(19) United States
(12) Patent Application Publication
(10) Pub. No.: US 2021/0187781 A1
(43) Pub. Date: Jun. 24, 2021

(54) METHOD OF IMPROVING THE HYDROPHOBIC PROPERTIES OF CELLULOSIC MATERIALS WITHOUT LEAVING AN ACIDIC RESIDUE

(71) Applicant: Woodholdings Environmental, Inc., Scottsdale, AZ (US)

(72) Inventors: Edwin Neal, Scottsdale, AZ (US); Fred Donald Lowder, Amarillo, TX (US); Robert William Morton, Bartlesville, OK (US)

(21) Appl. No.: 17/125,921

(22) Filed: Dec. 17, 2020

Related U.S. Application Data
(60) Provisional application No. 62/950,814, filed on Dec. 19, 2019.

(51) Int. Cl. B27K 3/02; B27K 3/16

(52) U.S. Cl. CPC B27K 3/0271; B27K 3/0285; B27K 2240/70; B27K 3/16; B27K 3/0214

(57) ABSTRACT

A method for improving the hydrophobic properties of a cellulosic material having a measurable moisture content without leaving an acidic residue comprises immersing the material in an inert gas, treating the material at a first temperature of between about 180° F. and about 250° F. with a vapor of silane until the silane reacts with the moisture to form hydroxysilanes and an acid vapor, then treating the material at a second temperature of between about 280° F. and about 350° F. until the hydroxysilanes convert to dehydrated silanes that are diffusely resident in the material, and removing the moisture, the acid vapor and remaining silane vapor until the treated material is substantially acid free.

### CROSS-REFERENCE TO RELATED APPLICATIONS

This application claims the benefit of Provisional Application No. 62/950,814, filed Dec. 19, 2019, which is incorporated by reference.

### BACKGROUND

### Technical Field

The present disclosure relates to a process of treating fibers, cellulose, and wood with silanes and forming water resistant products of the same. in particular, the present disclosure relates to the treatment of cellulosic material with a vapor of a silane to impregnate it with dehydrated silane to improve the hydrophobic properties of the material without adding any significant acidity.

### Description of Related Art

The production of wood based composite panel products or engineered lumber has increased dramatically in recent years. Oriented strand board (OSB) production has exceeded that of plywood in order to continue this new growth, additional uses for OSB need to be developed. Common applications for these products include roof sheathing, wall sheathing, flooring, structural insulated panels, and engineered wood components such as Hoists. Greater use of engineered lumber has been limited by prevailing manufacturing techniques which leave a residue of acid in the material that can degrade the material over time, and also leave the material susceptible to water damage.

The use of medium density fiberboard and hardboard panel products likewise has increased dramatically over the last several decades. However, these products are typically used in interior applications where attack from insects or fungi is limited and dimensional stability is not of great concern. The market for these types of materials is fairly well developed.

The expansion of wood fiber, particle and flake-based composites into other construction applications is hindered by limitations in the physical and mechanical properties of the manufactured panels, in particular excessive water absorption and the resultant propensity to swell, but also by their susceptibility to attack by biological agents such as fungi and termites, make it unsuitable for applications in et or potentially wet environments, For example, flooring or subflooring of OSB panels is often installed before a water or weatherproof exterior has been completed, leaving the installed OSB flooring/sub-flooring exposed to weather and moisture until windows and other features are completed. During the interim installation period, the OSB may be exposed to undesired moisture, a mere risk of which (with the attendant swelling of the OSB) has led to avoidance of its use.

Chemical preservatives and water repellent treatments are available for solid lumber and plywood. Such chemical treatments are applied to lumber, millwork, wood plies, and so forth using vacuum pressure processes to ensure uniform distribution of the active ingredients throughout the wood components. Treated woods find application in the construction of residential housing and commercial buildings.

Historically, attempts to incorporate chemical treatments into wood-based composites using similar technology have failed for economic reasons or more commonly because of technical problems associated with irreversible and excessive swelling of the treated panels and severe loss of structural integrity. As seen in FIG. 1, prior art treatments of cellulosic material rely on wetting the material with a chlorosilane solution made by dissolving the chlorosilane in a petroleum base. Although the chlorosilane reacts with water in the material, leading to the beneficial formation of dehydrated silanes, hydrochloric acid remains entrapped in the materials which reduces the structural integrity of the material over time. Moreover, the penetration of the dehydrated silanes into the materials is incomplete leaving the material vulnerable to water damage. Conventional methods to neutralize the acid still leave a residue of acid, particularly in the core of a sheet of a manufactured cellulose product, that degrades the product over time.

The development of an economically viable water repellent treatment for solid wood, plywood, and, particularly, wood-based composites with minimal or no impact on board structural properties would be desirable to the industry and consumers.

The development of such products also would have a significant impact upon forest resources since a solid wood or a formed panel product that has been treated to be inherently stable to resist water will significantly increase the service life of the final wood product. Hence, replacement of damaged, decayed, or destroyed panels will be less frequent and more solid wood and wood fiber could be channeled to new construction instead of to the replacement market to use these forest resources more efficiently. Additionally, control and constrains on installation, could be relieved or lessened, making its use more widely accepted.

### SUMMARY OF THE INVENTION

The present disclosure provides a method of improving the hydrophobic properties of a cellulose material. The method is applicable to cellulose material having a measurable moisture content, If desirable, the cellulose material may be dried to bring the moisture content within the range of about 2% to about 40%. The method comprises immersing the material in an inert gas and then heating it to a temperature Thin a range of about 180° F. to about 250° F. The material is then treated with a vapor of a silane until the silane reacts with the water moisture to form hydroxysilanes and an acid vapor. If the silanes are chlorosilanes, a vapor of hydrochloric acid will form. The material is then treated at a second temperature of between about 280° F. and about 350° F. until the hydroxysilanes convert to dehydrated silanes which are diffusely distributed on and within the materials thereby improving their hydrophobic properties, During treatment, moisture, the acid vapors, and silane that has not reacted with the moisture, evaporate and are removed until the materials are virtually acid free.

### BRIEF DESCRIPTION OF THE DRAWINGS

FIG. 1 is a representation of a prior art method of treating cellulose materials.

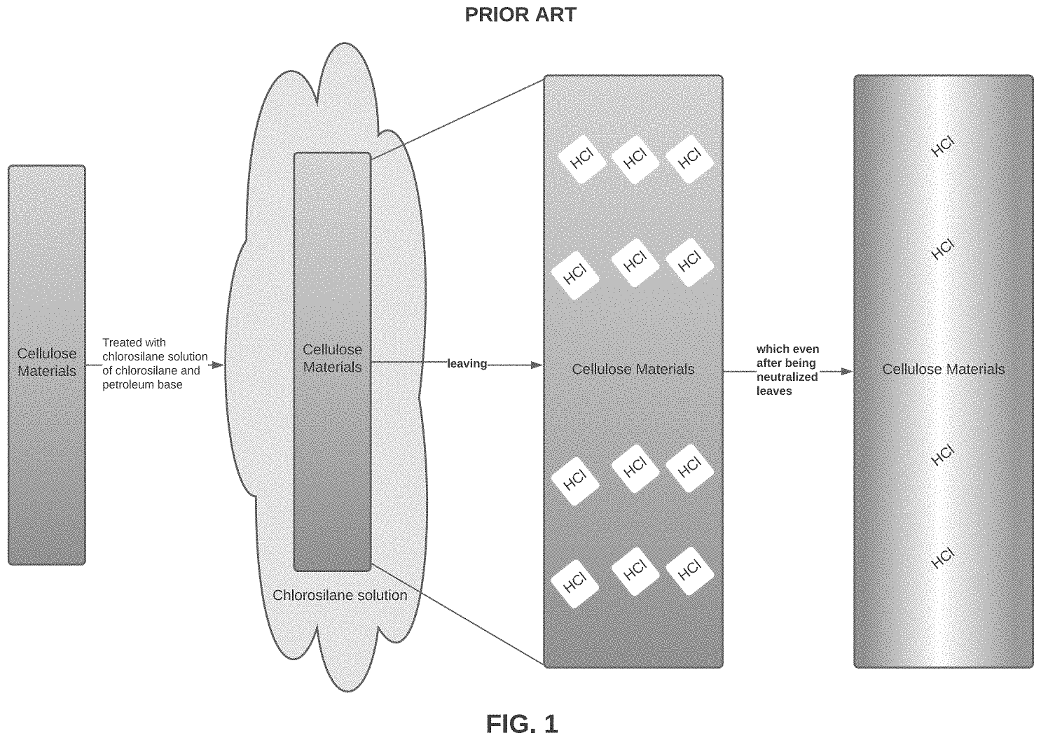

FIG. 2 is a representation of a method of treating cellulose materials according to the invention through the step resulting in the diffuse distribution of hydroxysilanes in the materials.

FIG. 3 is a continuation of FIG. 2 showing further steps of the method that result in dehydrated silanes being diffused through the materials,

FIG. 4 is a high-level representation of a system and equipment for carrying out the method described herein.

### DETAILED DESCRIPTION OF THE INVENTION

The present disclosure provides an efficient method of introducing dehydrated silanes into cellulose or wood materials to improve the water repellency of cellulose and wood products as well as composite materials. The method takes advantage of the reaction between silanes and water to form hydroxysilanes. Thus, the method to be effective requires the presence of some moisture in the materials. Conversely, too much moisture in the materials may frustrate optimally efficient application of the method, Therefore, it may be desirable in some instances to dry the materials to lower the moisture content to between about 2% to about 40%.

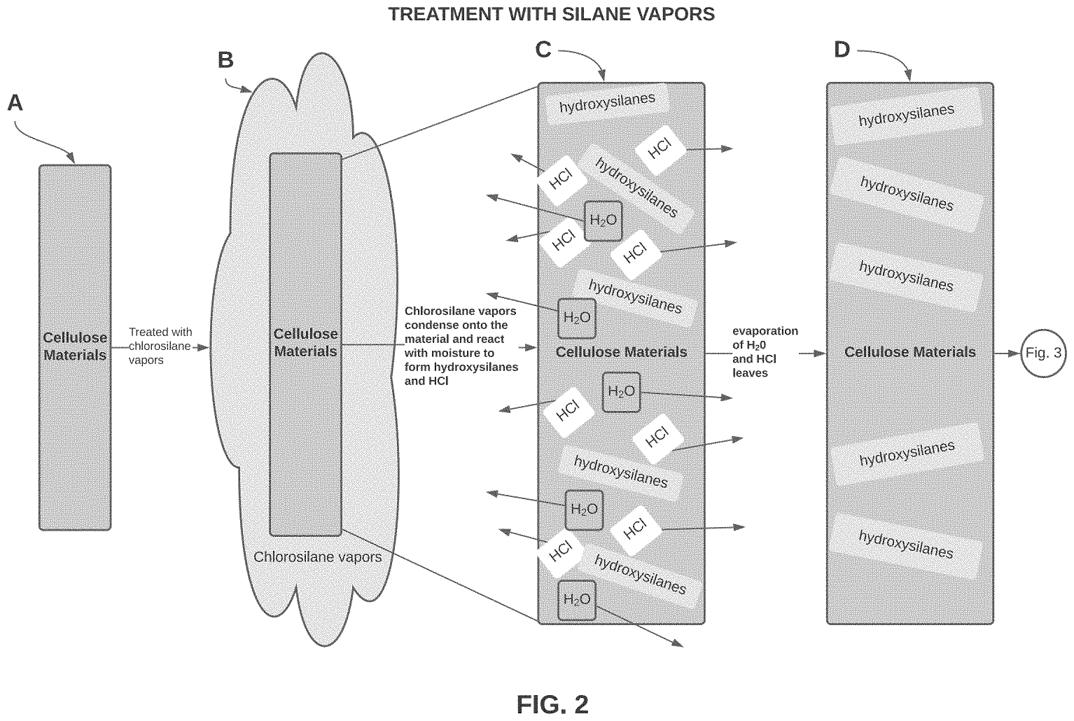

With reference to FIG. 2, according to one implementation of the invention, materials A having a moisture content as mentioned above are immersed in an inert gas that creates an environment in which the silane vapors can be safely introduced yet avoid volatility. Suitable inert gases include, without limitation, nitrogen, carbon monoxide, helium, carbon dioxide and argon.

The materials are then heated to a first temperature of between about 180° F. and about 250° F. and exposed to a vapor of silane at B until the silane reacts with water moisture present in the materials to form hydroxysilanes at C. In one implementation of the invention the first temperature range is between about 212° F. and about 250° F. A byproduct of the reaction is acid which forms as a gas. In one implementation of the invention, the silane is a chlorosilane in which case the acid produced is hydrochloric acid (HCl) The chlorosilane vapor condenses onto the cellulose material and reacts with vaporous water (water moisture), water adsorbed on the material, and chemical water, leaving behind hydroxysilanes directly on, and in voids and pores in, the material, as represented at D. The hydrochloric acid evaporates from the material through static evaporation or via a moving transport medium such as a gas or a gas mixture. One particular advantage of the method is that HCl associates strongly with the water moisture which, since the water s evaporating from the material, promotes evaporation of the HCl from the material.

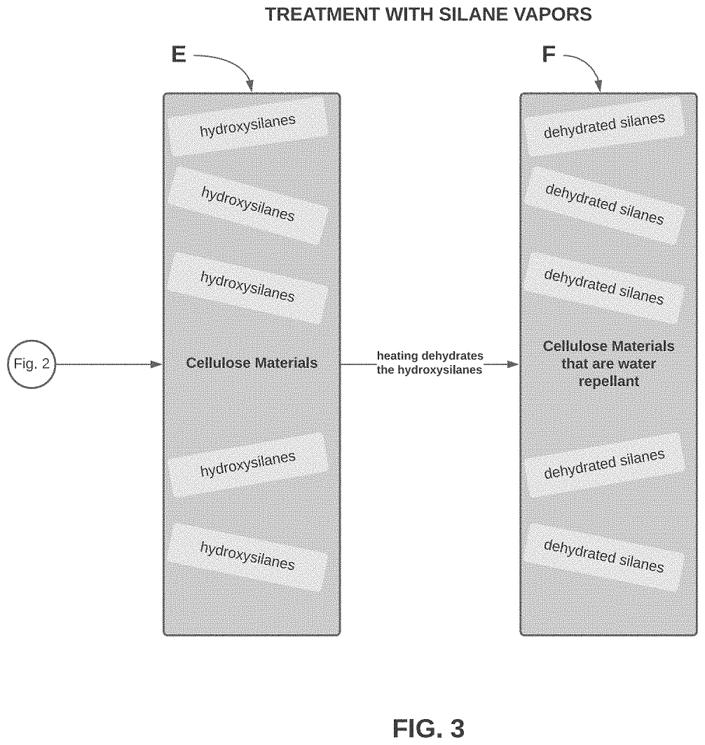

With additional reference now to FIG. 3, after treatment of the material at the first temperature, which as mentioned above leaves hydroxysilanes diffusely resident on and through it, the material, at E, is treated at a second temperature between about 280° F. and 350° F. until the hydroxysilanes are converted to dehydrated silanes, at F. In one implementation of the method, the range for the second temperature is between about 280° F. and 330° F. The treatment results in dehydrated silanes surrounding the material, and penetrating into the voids and pores therein, improving the hydrophobic properties of the material.

The treatment at the second temperature causes further evaporation of the water moisture and of the HCl which, as mentioned above, associates strongly with the water vapor. Silanes that have not reacted with water moisture in the materials also continue to evaporate. The water moisture, acid vapor and remaining vapor of silane are removed from the proximity of the materials by sweeping them away in a stream of the inert gas or by use of a vacuum.

The result of the treatment is that the materials have greatly improved hydrophobic properties without adding significant acidity to the material. Virtually no acid remains in the materials when treated according to the invention disclosed herein. Applicants have determined that the pH of the material after treatment is not significantly different than that of the untreated material.

Silanes useful in practicing the disclosed method include, without limitation: methyltrichlorosilane (MeSiCl₃), (chloromethyl) trichlorosilane; [3-(heptafluoroisoproxy)propyl]trichlorosilane; 1,6-bis(trichlorosilyl)hexane; 3-bromopropyltrichlorosilane; allylbromodimethylsilane; allyltrichlorosilane; bromomethylchlorodimethylsilane; bromothimethylsilane; chloro(chloromethyl)dimethylsilane; chlorodiisopropyloctylsilane; chlorodiisopropylsilane; chlorodimethylethylsilane, chlorodimethylphenylsilane; chlorodimethylsilane; chlorodiphenylmethylsilane; chlo otriethylsilane; chlorotrimethylsilane; dichlorodimethylsilane; dichloromethylsilane; dichloromethylvinylsilane; diphenyldichlorosilane; di-t-butylchlorosilane; ethyltrichlorosilane; lodotrimethylsilane; pentyltrichlorosilane; phenyltrichlorosilane; trichloro(3,3,3-trifluoropropyl)silane; trichloro(dichloromethyl)silane; and trichlorovinylsilane.

In one embodiment, the silane comprises methyltrichlorosilane, both for its chemical properties, the production of the improved structure of the cellulose, and for economics in procuring a low cost and readily available silane. In other embodiments, the cellulose material is treated with a halosilane, a plurality of halosilanes, a chlorosilane, or a plurality of chlorosilanes.

Types of cellulose materials that can benefit from treatment with the silanes of the disclosure include sawn timber, logs, glulam (glued laminated lumber), dimensional lumber, plywood, laminated veneer lumber (LVL), wood based composite products such as oriented strand board (OSB) and wood chips for making the same, medium density fiberboard (MDF) and wood fibers for making the same, fiberboard, hardboard and particle board. It will be understood that “wood” in the context of this invention does not encompass living trees or other plants. Other cellulose or cellulosic materials that can benefit from treatment with the silanes of the disclosure are lignocellulosic substrates, wood plastic composites, cardboard and cardboard faced building products such as plasterboard, and cellulosic material such as cotton. Also rice fiber as well as other fiber from both endogenous and exogenous sources, as well as paper, cardstock, cardboard, or the like. Fibers for clothing, textiles, performance clothing and athletic wear, tents, cardboard, boxes, shipping materials, storage for food products, beverages, liquids, bulk chemicals or dry goods, paper, notebooks, field materials, emergency shelters, tarps, tents, ropes, mountaineering and outdoor rescue or construction equipment. Applications for tropical, marine, or humid environments are also contemplated. Also, leather, textile materials and even synthetic fibers, hessian, rope and cordage as well as composite wood materials. For convenience, the present disclosure provides a description with reference to the treatment of cellulose material, but it will be appreciated that all of the above and other cellulosic materials may be treated analogously, and for ease of description are referred to herein as “cellulose material” or “cellulosic material.” In one aspect of the invention, the cellulose material comprises wood pieces used to produce a wood-based composite product, including OSB and MDF.

As noted herein, cellulose material treated as described herein will have water resistant properties which, e.g., when dealing with treated flakes may be combined in a conventional process to form improved OSB that is less susceptible to swelling, such as by the fibers in the cellulose material, such as the wood flakes, being bound by the web-like structure that prevents the fibers from taking on water, and separating when they do, causing the cellulose material to swell. Even when water is introduced into air voids of OSB formed with treated wood flakes, the weight of the OSB may increase (the air voids being filled with water), but the OSB will have little or no swelling, the wood fibers being retained in position by the web-like structure. Furthermore, surface tension of water limits penetration of water into structure of treated cellulose material. A corresponding advantage of the material not swelling is that it retains its structural integrity even after having been exposed to water. Table 1 below shows the percent of swelling when exposed to water of conventional OSB, commercially available OSB that has been treated with additional resin/glue/force to become more water resistant, and OSB formed with wood flakes treated with silane as described herein.

TABLE 1

| | Swelling (Percent increase in size |
|---|---|
| Material | due to exposure to water) |
| Conventional OSB | 28-35% |
| Conventional water | 8-10% |
| resistant OSB | |
| OSB made of | 0-5% |
| Silane treated flakes | |

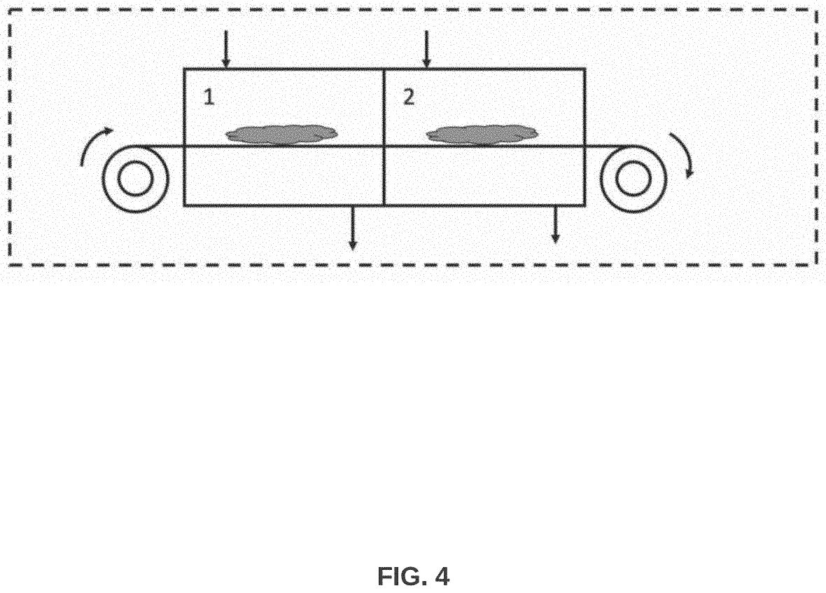

FIG. 4 shows a process flow diagram for the method described herein. The cellulose material to be treated, such as wood chips, may be moved on a feed roll, uptake roll, or conveyor belt, to, and then from, a first processing chamber to a second processing chamber (labeled 1 and 2, respectively in FIG. 4), where the cellulose material, such as wood chips is treated. In other instances, the first and second processes may occur n a single chamber or location, the first and second processes happening serially, one after the other. In yet other instances, additional steps, treatments, or processes may occur before, after, or between what is disclosed or is shown in the exemplary arrangement of FIG. 4 and occurring within the area denoted as a dashed box in FIG. 4. For example, before entering the first chamber the cellulose material may be in a storage area or treatment area in which the cellulose material is dried or arrives at a moisture content level in a desired range such as 10-30% or 10-20%. By way of example, green or fresh wood chips freshly formed from lumber or wood may have a moisture content at or about 50% and will be dried or cured until the moisture content level in a range of 10-30% or 10-20%.

Furthermore, after the treatment process included within the dashed box shown in FIG. 4, the cellulose material, such as wood chips for OSB, may be moved on to additional storage areas or bins, from which they may undergo subsequent processing. By way of illustration, for the formation of OSB, the wood chips will be mixed with one or more resins, glues, or both and then placed under pressure in a press until formed into a panel or substrate.

The cellulose material may pass through the treatments described herein and shown as the treatment apparatus of the system illustrated in FIG. 4 as the dashed box. The cellulose material may be collected on the conveyor, the cellulose material entering a first zone, area, or chamber 1 in which may be an inert zone comprised of first inert gas, such as nitrogen, The inert gas may be supplied to the first chamber by an inlet zone, nozzle, spigot, perforated pipe or other ingress, as indicated by the upper arrow downwardly pointing to chamber 1. An egress or outlet from the first chamber by or through an outlet zone, nozzle, spigot, perforated pipe or other egress, as indicated by the lower arrow downwardly pointing from the chamber 1 is also indicated in FIG. 4. The inert gas inlet zone and first vapor outlet zone may comprise one single chamber, as indicated as chamber 1, and alternatively, may comprise or be subdivided into one or more separate chambers separated by a zone divider such as, for example, a curtain or soft baffle.

Chamber 1 or zone 1, may also be a treatment zone in which the first treatment occurs. The cellulose material may be treated by the vapor described above and may be introduced through an inlet that may be the same or different as that of the inert gas, which is represented by the upper downward facing arrow into chamber 1 as shown in FIG. 4. The vapor may be introduced by any convenient means, such as through a nozzle or orifice. The vapor may be directed perpendicular to the cellulose material, and the vapor may have a turbulent flow that may be achieved by any convenient means, such as use of an agitator or impeller in the treatment zone. Alternatively, turbulent flow (as well as agitation of the cellulose material) may be achieved by using baffles, by selection of vapor flow rate through the inlet, or combinations thereof. In the first step or process of treating the cellulose material, all sides of the cellulose material should be exposed to the vapor. As such, the cellulose material, such as wood chips for subsequently formed OSB, may be agitated, stirred, vibrated, tumbled, spun, flipped, turned, or moved in, into, or on, a hopper, trommel, screen, tumbler, or vibrating belt or conveyor, or otherwise moved or positioned within the vapor (including on the conveyor) to allow the vapor to penetrate the cellulose material in the treatment zone or first chamber 1. The treating vapor can be moved through the chamber such as by a flow to an exhaust fan at the egress and may be done by a negative pressure in the first chamber (such as on the order of negative 10 pounds) or may utilize both.

The cellulose material may then remain in the first chamber or pass through a zone divider into another chamber or portion of the chamber 1 that serves as a vent zone. One skilled in the art will recognize that FIG. 4 is exemplary and not limiting. Modifications may be made without limiting the scope of the invention set forth in the claims. For example, a first inert gas inlet zone and first vapor outlet zone may be combined in one chamber, e.g., the first chamber or chamber 1, or in other instances may be separate chambers or treatment areas.

After the cellulose material is treated in the first chamber, the cellulose material may be moved to the second chamber or chamber 2, for the second heating or curing process to form the final silicon based compounds. The second chamber may also include an egress vent, exhaust, or fan, similar, identical, or different than that of the first chamber, the exhaust of the second chamber serving to provide flow through the second chamber, and for exhausting HCl fumes. In some instances, the second heating, or the heating to the elevated temperature described above, may occur in the same first chamber. In some instances, the second treatment at elevated temperature may be for a lesser duration if the heated cellulose material is stored together and residual heat is maintained with the cellulose material, allowing the reaction to continue even after being removed from the first or second chamber.

The method may be performed under ambient conditions of pressure. Alternatively, the method may be performed at reduced pressure in one or more zones or chambers. The method may include heating in one or more zones as described above. For example, the treatment zone, and any other zone, may be maintained at a desired temperature to help drive reactions. Minimizing or reducing an amount of time between the treatments in the first and second chamber may also be reduced or minimized to carry heat and energy in the cellulose from the first chamber or process to the second chamber or process without a significant loss of heat and the need to reheat the cellulose material.

While the system and method of the invention has been described in considerable detail in the foregoing specification and accompanying drawings, it is not intended that the invention be limited to such detail. It will be readily apparent to persons of ordinary skill in the art that variations of the described embodiments are possible without departing from the spirit and scope of the invention as reflected in the following claims. Nor is the system and method of the invention intended to be limited by the application described herein. Other applications, whether currently known or unknown, are or in the future may be possible, again without departing from the spirit and scope of the invention as reflected in the following claims.

We claim:

1. A method for improving the hydrophobic properties of cellulosic material without leaving an acidic residue, the method comprising:
immersing the material in an inert gas, the materials having measurable moisture content,
heating the material to a temperature of between about 180° F. and about 350° F.,
treating the material with a vapor of silane until the silane reacts with the water moisture to form hydroxysilanes that are diffused throughout the material.

2. The method for improving the hydrophobic properties of cellulosic material without leaving an acidic residue of claim 1, the method further comprising:
drying the material, if needed, until the material has a moisture content of between about 2% and about 40%, the material comprising cellulose.

3. The method for improving the hydrophobic properties of cellulosic material without leaving an acidic residue of claim 1, wherein
The material has a moisture content of between about 2% and about 10%.

4. The method for improving the hydrophobic properties of cellulosic material without leaving an acidic residue of claim 1, wherein
the silane comprises a chlorosilane.

5. The method for improving the hydrophobic properties of cellulosic material without leaving an acidic residue of claim 4, wherein
the chlorosilane comprises methyltrichlorosilane.

6. The method for improving the hydrophobic properties of cellulosic material without leaving an acidic residue of claim 4, wherein
the chlorosilane vapors condense on and penetrate the material such that the reaction thereof with water leaves behind hydroxysilanes on and in the material.

7. The method for improving the hydrophobic properties of cellulosic material without leaving an acidic residue of claim 1, the method further comprising:
treating the material with the vapor of silane at a first temperature of between about 180° F. to about 250° F. until the hydroxysilanes are diffused throughout the material, and then
treating the material at a second temperature of between about 280° F. and about 350° F. until the hydroxysilanes are converted to dehydrated silanes, these silicon-based compounds increasing the hydrophobic properties of the materials.

8. The method for improving the hydrophobic properties of cellulosic material without leaving an acidic residue of claim 7, wherein
the first temperature is between about 212° F. and about 250° F.

9. The method for improving the hydrophobic properties of cellulosic material without leaving an acidic residue of claim 7, wherein
The duration of the treatment at the first temperature is between about 5 seconds and about 5 minutes.

10. The method for improving the hydrophobic properties of cellulosic material without leaving an acidic residue of claim 9, wherein
the duration of the treatment at the first temperature is between about 5 seconds and about 30 seconds.

11. The method for improving the hydrophobic properties of cellulosic material without leaving an acidic residue of claim 7, wherein
the treatment at the second temperature is between about 280° F. and about 330° F.,

12. The method for improving the hydrophobic properties of cellulosic material without leaving an acidic residue of claim 7, wherein
the duration of the treatment at the second temperature is between about 1 second and about 5 minutes.

13. The method for improving the hydrophobic properties of cellulosic material without leaving an acidic residue of claim 12, wherein
The duration of the treatment at the second temperature is between about 5 seconds and about 30 seconds.

14. The method for improving the hydrophobic properties of cellulosic material without leaving an acidic residue of claim 1, wherein
the inert gas is selected from the group consisting of nitrogen, carbon monoxide, helium, carbon dioxide, and argon.

15. The method for improving the hydrophobic properties of cellulosic material without leaving an acidic residue of claim 7, the method further comprising:
after treating the material with the vapor of silane, removing away from the materials the water moisture, any acid vapor formed by reaction of the chlorosilanes with the water moisture, and any vapors of silane, that have evaporated from the material.

16. The method for improving the hydrophobic properties of cellulosic material without leaving an acidic residue of claim 4, the method further comprising:
after treating the material with the vapor of silane, removing away from the materials the water moisture, any acid vapor formed by reaction of the chlorosilanes with the water moisture, and any vapors of silane, that have evaporated from the material until the treated material has an acidity not significantly different than the acidity of the material before treatment.

17. The method for improving the hydrophobic properties of cellulosic material without leaving an acidic residue of claim 16, the method further comprising:
removing the acid vapor that has evaporated during treatment until the treated material has no significantly greater acidity than the acidity of the material before treatment.

18. The method for improving the hydrophobic properties of cellulosic material without leaving an acidic residue of claim 16, wherein
the silane comprises a chlorosilane, and
the acid comprises hydrochloric acid.

19. The method for improving the hydrophobic properties of cellulosic material without leaving an acidic residue of claim 1, wherein
the silane is a halosilane selected from the group consisting of methyltrichlorosilane, dimethyldichlorosilane, (chloromethyl)trichlorosilane [3-(heptafluoroisoproxy)propyl]trichlorosilane, 1,6-bis(trichlorosilyl)hexane, 3-bromopropyltrichlorosilane, bromotrimethylsilane, allylbromodimethylsilane, allyltrichlorosilane, (bromomethyl)chloodimethylsilane, chloro(chloromethyl)dimethylsilane, bromodimethylsilane, chloro(chloromethyl)dimethylsilane, chlorodiisopropyloctylsilane, chlorodiisopropylsilane, chlorodimethylethylsilane, chlorodimethylphenylsilane, chlorodimethylsilane, chlorodiphenylmethylsilane, chlorotriethylsilane, chlorotrimethylsilane, dichloromethylsilane, dichlorodimethylsilane, dichloromethylvinylsilane, diethyldichlorosilane, diphenyldichlorosilane, di-t-butylchlorosilane, ethyltrichlorosilane, iodotrimethylsilane, octyltrichlorosilane, pentyltrichlorosilane, propyltrichlorosilane, phenyltrichlorosilane, triphenylsilylchloride, tetrachlorosilane, trichloro(3,3,3-trifluoropropyl)silane, trichloro(dichloromethyl)silane, trichlorovinylsilane, hexachlorodisilane, 2,2-dimethylhexachlorotrisilane, dimethyldifluorosilane, bromochlorodimethylsilane, and combinations thereof.

20. The method for improving the hydrophobic properties of cellulosic material without leaving an acidic residue of claim 1, wherein
the cellulose material comprises wood pieces used to produce a wood based composite product selected from the group consisting of oriented strand board (OSB), medium density fiberboard (MDF), fiberboard, hardboard, particle board, dimensional lumber, cotton, cardboard and paper.

21. The method for improving the hydrophobic properties of cellulosic material without leaving an acidic residue of claim 1, wherein
the silane is applied at a rate of less than 10 pounds per US ton.

22. A method for improving the hydrophobic properties of cellulosic material without leaving an acidic residue, the method comprising:
immersing the material in an inert gas, the materials having measurable moisture content,
heating the material to a first temperature of between about 180° F. and about 250° F., treating the material with a vapor of a chlorosilane at the first temperature until
the silane reacts with the water moisture to form hydroxysilanes and a vapor of hydrochloric acid, the hydroxysilanes diffused throughout the material,
treating the material at a second temperature of between about 280° F. and about 350° F. until the hydroxysilanes are converted to dehydrated silanes, these silicon-based compounds increasing the hydrophobic properties of the materials, and
removing away from the material the water moisture, the vapor of hydrochloric acid, and any vapors of silane, that have evaporated from the material.

23. A method for improving the hydrophobic properties of cellulosic material without leaving an acidic residue, the method comprising:
drying the material, if needed, until the material has a moisture content of between about 2% and about 10%, the material comprising cellulose,
immersing the material in an inert gas,
heating the material to a first temperature of between about 212° F. and about 250° F.,
treating the material with a vapor of methyltrichlorosilane at the first temperature until the methyltrichlorosilane reacts with the water moisture to form hydroxysilanes and a vapor of hydrochloric acid, the hydroxysilanes diffused throughout the material,
treating the material at a second temperature of between about 280° F. and about 330° F. until the hydroxysilanes are converted to dehydrated silanes, these silicon-based compounds increasing the hydrophobic properties of the materials, and
removing away from the material the water moisture, the vapor of hydrochloric acid, and any vapors of methyltrichlorosilane, that have evaporated from the material.
